(19) United States
(12) Patent Application Publication
(10) Pub. No.: US 2025/0136218 A1
(43) Pub. Date: May 1, 2025

(54) SEAT ASSEMBLY OF VEHICLE

(71) Applicant: COMPAL ELECTRONICS, INC., Taipei (TW)

(72) Inventors: HSIN CHEN, Taipei (TW); TUNG-YING WU, Taipei (TW); KUAN-CHANG LEE, Taipei (TW); SHI-KUAN CHEN, Taipei (TW)

(73) Assignee: COMPAL ELECTRONICS, INC., Taipei (TW)

(21) Appl. No.: 18/922,443

(22) Filed: Oct. 22, 2024

Related U.S. Application Data
(60) Provisional application No. 63/545,745, filed on Oct. 25, 2023.
(60) Provisional application No. 63/601,760, filed on Nov. 22, 2023.

(51) Int. Cl. B62J 9/14; B62J 1/08

(52) U.S. Cl. CPC B62J 9/14; B62J 1/08

(57) ABSTRACT

A vehicle seat assembly, suitable for vehicles such as locomotives and the like, includes a main cushion body and a lifting cushion. The main cushion body has a sliding cushion connected to a vehicle body with a sliding structure. The lifting cushion is connected to the vehicle body with a linkage mechanism. The lifting cushion is moved into a carriage when the sliding cushion is in a first position, and when the sliding cushion slides laterally into a second position to form a space portion, the lifting cushion can be lifted from the carriage and moved into the space portion and then positioned, or can be lowered into the carriage again, so that the sliding cushion can be moved back to the first position, thereby allowing the user to adjust seat cushion length according to their needs.

### CROSS-REFERENCE TO RELATED APPLICATION

This non-provisional application claims priority under 35 U.S.C. § 119 (e) on U.S. provisional Patent Application Nos. 63/545,745 and 63/601,760, filed on Oct. 25, 2023 and Nov. 22, 2023, respectively, the entire contents of which are hereby incorporated by reference.

### BACKGROUND OF THE INVENTION

### 1. Field of the Invention

The present disclosure relates to a seat assembly of a vehicle, and in particular to a seat assembly capable of adjusting a seat cushion length.

### 2. Description of the Related Art

Locomotives are one of most common transportation means in the daily life, and can be roughly categorized into light locomotives and heavy locomotives according to engine displacement. In addition to existing two-wheel locomotives, there are also locomotives designed with three wheels or even four wheels in the aim of enhancing riding stability. Users can choose appropriate vehicle models according to requirements when purchasing.

However, regardless of which type of vehicle models, specifications of various components of a locomotive are fixed when shipped out of the factory. For example, the length of a seat cushion cannot be adjusted afterward as desired. If a user chooses a light locomotive for compactness and easy steering during riding, the seating space may be overcrowded for multiple passengers due to a shorter length of the seat cushion, reducing riding comfort. Thus, a user may often choose a heavy locomotive instead of a light locomotive with compactness and easy steering in order to satisfy requirements for a sufficient seat cushion length. In this case, although comfort can be provided for multiple passengers riding at the same time, for a female or elderly user, maneuvering difficulties may be caused due to the wider and heavier vehicle body of the heavy locomotive. For example, dilemmas of being unable to prop up a fallen locomotive are rather frequent. Moreover, there are individuals who purchase light locomotives to satisfy ease of maneuvering of one single rider/passenger and also purchase heavy locomotives to satisfy riding comfort for multiple passengers, and this not only leads to high costs but also aggravates an issue of an overwhelming number of locomotives.

Therefore, it is an object of the present disclosure to provide a solution for solving the above issues of the prior art.

### BRIEF SUMMARY OF THE INVENTION

To solve the issues above, the applicant provides a seat assembly of a vehicle providing a seat with an adjustable length according to riding requirements.

To achieve the object above, the present disclosure provides a seat assembly of a vehicle. The vehicle includes in a vehicle body thereof a carriage for a user to place objects. The seat assembly is adapted to be disposed at the vehicle body and can open or close an opening of the carriage. The seat assembly includes: a main cushion body including a sliding cushion, the sliding cushion connected to the vehicle body by a sliding structure in between, so that the sliding cushion is laterally slidably arranged over the opening, wherein the sliding cushion is laterally slidable between a first position and a second position, the opening is closed by the main cushion body when the sliding cushion is at the first position, and the main cushion body forms a space portion in communication with the opening when the sliding cushion is at the second position; and a lifting cushion, connected to the vehicle body by a linkage mechanism in between and thus capable of moving into the carriage, the lifting cushion being at a position aligned with the space portion and thus capable of longitudinally moving inside and outside the opening. When the sliding cushion is at the first position, the lifting cushion is moved into the carriage; when the sliding cushion slides laterally to the second position and the space portion is formed, the lifting cushion can ascend from the inside of the carriage, move into the space portion and be positioned, or the lifting cushion can again descend and move into the carriage, allowing the sliding cushion to move back to the first position.

In one embodiment, two sidewalls disposed adjacent to two opposite inner walls inside the carriage are further included. The two sidewalls are parallel to each other inside the carriage, and are structurally mirror-symmetrical. The sliding structure is arranged between the sliding cushion and the two sidewalls, and the linkage mechanism is arranged between the lifting cushion and the two sidewalls.

In one embodiment, the linkage mechanism is provided with a set of a first link rod and a second link rod in a crossing manner corresponding to each of the sidewalls. Two ends of the first link rod have a first top end and a first bottom end, respectively, and two ends of the second link rod have a second top end and a second bottom end, respectively. The first bottom end and the second bottom end are movably connected to the sidewall where they are disposed, and the first top end and the second top end are movably connected to the lifting cushion. When the first link rod and the second link rod move relatively, the first top end moves close relative to the second top end and the first bottom end moves close relative to the second bottom end, and the lifting cushion is linked and thus ascends; or the first top end moves away relative to the second top end and the first bottom end moves away relative to the second bottom end, and the lifting cushion is linked and thus descends.

In one embodiment, a bottom of the lifting cushion has a first pivot hole and a first guide groove on each of two opposite sides, and the first pivot hole and the first guide groove on each side are arranged respectively in front of and behind the lifting cushion. Each of the two sidewalls has a second pivot hole disposed corresponding to the two first pivot holes, and has a second guide groove disposed corresponding to the two first guide grooves. Each of the first link rods has, at the first top end, a first rod pivoted in the first pivot hole on the same side of the lifting cushion, and each of the first link rods has, at the first bottom end, a second rod slidably disposed in the second guide groove of the sidewall on the same side. Each of the second link rods has, at the second top end, a third rod pivoted in the first guide groove on the same side of the lifting cushion, and each of the second link rods has, at the second bottom end, a fourth rod slidably disposed in the second pivot hole.

In one embodiment, a reset elastic member is further included. The reset elastic member is connected between the first link rod and the second link rod, so that the first link rod and the second link rod normally tend to have the first top end to be close relative to the second top end and the first bottom end to be close relative to the second bottom end, so as to keep a tendency of the lifting cushion rising normally.

In one embodiment, the two sidewalls are connected integrally by a connecting wall on one side inside the carriage, the two sidewalls and the connecting wall form a flip-up frame having a hollow top and a hollow bottom, and the flip-up frame has a first pivot portion protruding outward at a top end of the connecting wall. The vehicle body has, on the side of the carriage, a second pivot portion disposed adjacent to the opening. The flip-up frame is pivoted with the first pivot portion and the second pivot portion and is thus rotatably connected to the vehicle body, for the sliding cushion and the lifting cushion to be able to flip out of the carriage from the opening along with rotation of the flip-up frame.

In one embodiment, the sliding structure includes two slide blocks and two slide channels. The two slide blocks are arranged on two sides of the sliding cushion, and the two slide channels are disposed at the two sidewalls and adjacent to the opening. The sliding cushion is slidably arranged in the two slide channels of the two sidewalls by the two slide blocks on the two sides thereof, so that the sliding cushion can linearly and horizontally move in accordance with travel distances of the two slide blocks in the two slide channels.

In one embodiment, the main cushion body further includes a fixed cushion. The fixed cushion is fixed to the vehicle body over the opening, and the space portion is formed between the fixed cushion and the sliding cushion moved to the second position.

In one embodiment, the sliding cushion has a first oblique angle on one side, the lifting cushion has a second oblique angle on one side, and slopes of the first oblique angle and the second oblique angle are the same. When the sliding cushion moves to the second position and the lifting cushion ascends and moves into the space portion, the first oblique angle and the second oblique angle abut against each other and block each other, so that the lifting cushion is positioned and is flush with the sliding cushion.

In one embodiment, the sliding cushion has a handle for a hand to hold and thus be slidable.

In the seat assembly of a vehicle of the present disclosure, the main cushion body is slidable between the first position and the second position via the sliding cushion, and the length of the main cushion body is thus adjusted in coordination with ascending and descending of the lifting cushion, so as to satisfy requirements for a seat cushion length in different riding scenarios for a user.

### BRIEF DESCRIPTION OF THE DRAWINGS

FIG. 1 is a schematic diagram of a seat assembly and a carriage according to a specific embodiment of the present disclosure.

FIG. 2 is a schematic diagram of an exploded configuration of a seat assembly according to a specific embodiment of the present disclosure.

FIG. 3 is a perspective schematic diagram of a seat assembly at a first position according to a specific embodiment of the present disclosure.

FIG. 4 is a cross-sectional schematic diagram of the structure observed along the section line 4-4 in FIG. 3.

FIG. 5 is a perspective schematic diagram of a seat assembly after a sliding cushion is moved backward and a space portion is formed according to a specific embodiment of the present disclosure.

FIG. 6 is a cross-sectional schematic diagram of the structure observed along the section line 6-6 in FIG. 5.

FIG. 7 is a perspective schematic diagram of a seat assembly at a first position according to a specific embodiment of the present disclosure.

FIG. 8 is a cross-sectional schematic diagram of the structure observed along the section line 8-8 in FIG. 7.

FIG. 9 is a schematic diagram of a flip-up frame of a seat assembly according to a specific embodiment of the present disclosure, wherein the flip-up frame flips out of a carriage for a hand to extend therein from an opening, and a sliding cushion of the seat assembly is at a first position.

FIG. 10 is another schematic diagram of a flip-up frame of a seat assembly according to a specific embodiment of the present disclosure, wherein the flip-up frame flips out of a carriage for a hand to extend therein from an opening, and a sliding cushion of the seat assembly is at a second position.

### DETAILED DESCRIPTION OF THE INVENTION

To facilitate understanding of the object, characteristics and effects of the present disclosure, embodiments together with the attached drawings for the detailed description of the present disclosure are provided below.

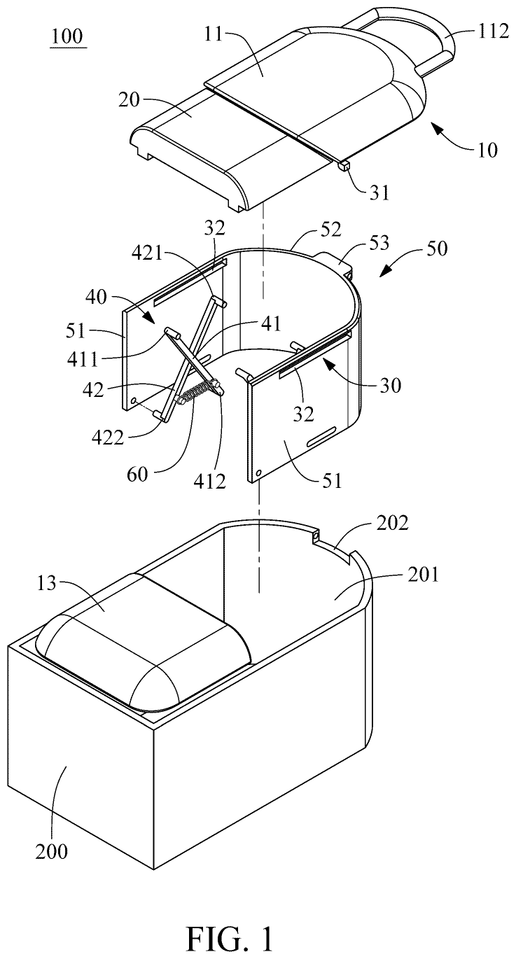

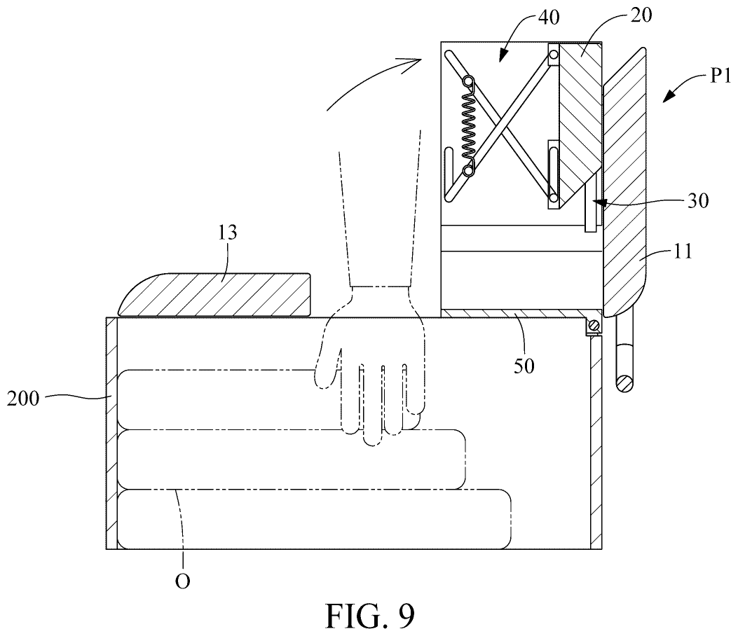

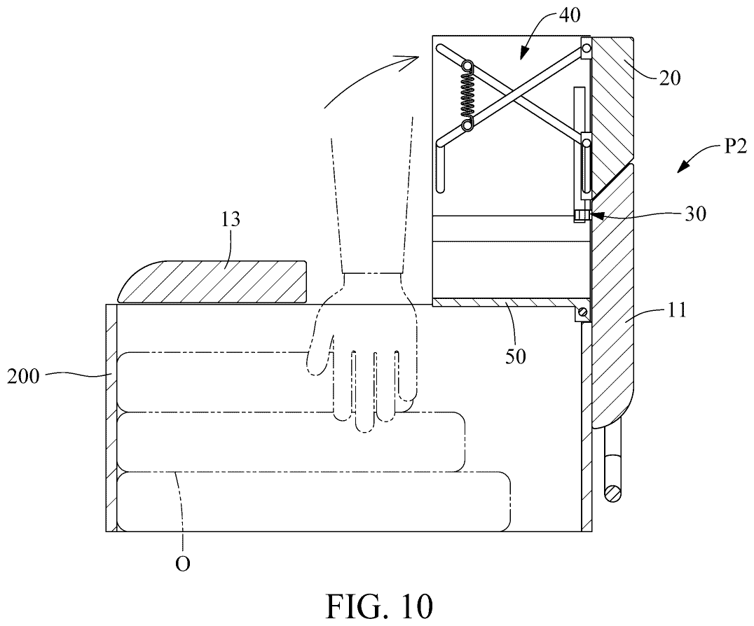

Referring to FIG. 1 to FIG. 10, the present disclosure provides a seat assembly 100 of a vehicle. The vehicle includes, in a vehicle body thereof, a carriage 200 for a user to place an object O (referring to FIGS. 9 and 10). The vehicle is a scooter in the embodiment below, and the scooter may be an electric vehicle or a fuel vehicle. The seat assembly 100 of a vehicle of the present disclosure is limited to being applied to a scooter, and any light and heavy vehicles having two wheels or three wheels or more are all encompassed within the scope of legal protection for “vehicle” of the present disclosure.

As shown in FIG. 1, the seat assembly 100 is adapted to be disposed at a vehicle body and can open or close an opening 201 of the carriage 200. The seat assembly 100 includes a main cushion body 10, a lifting cushion 20, a sliding structure 30 and a linkage mechanism 40, and further includes a flip-up frame 50 in an embodiment.

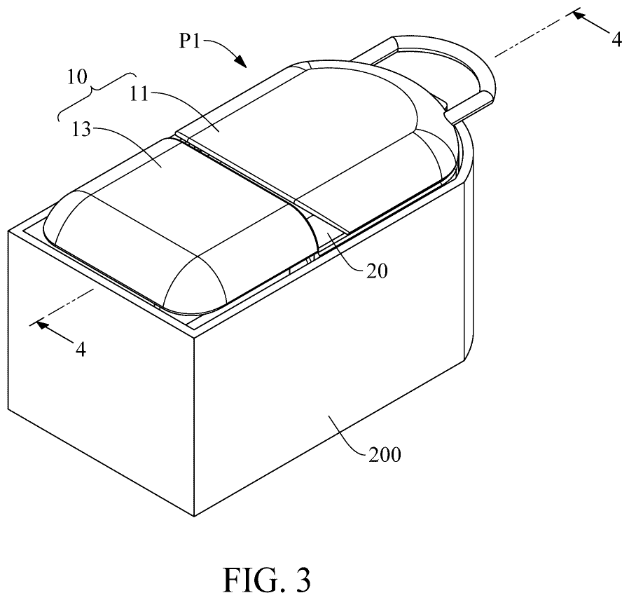

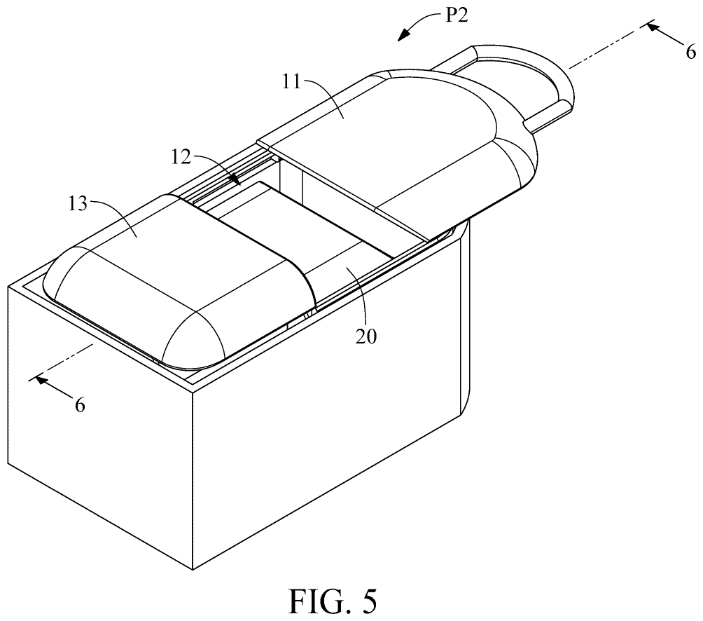

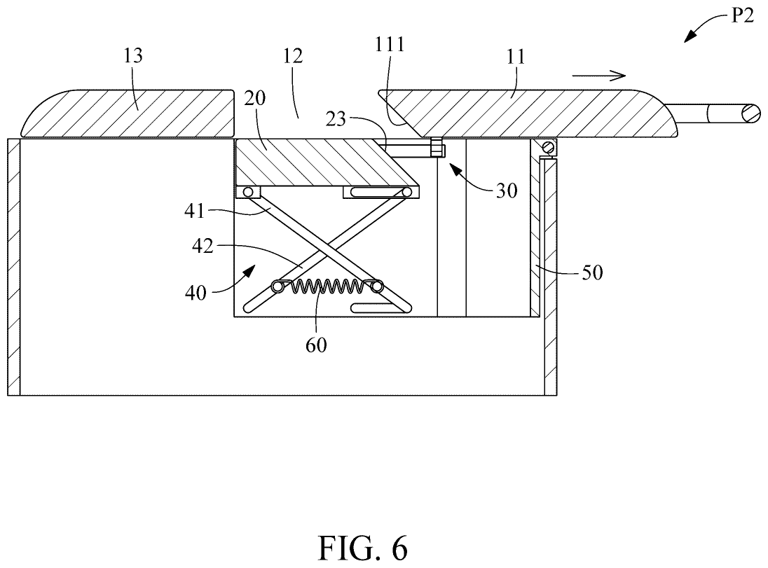

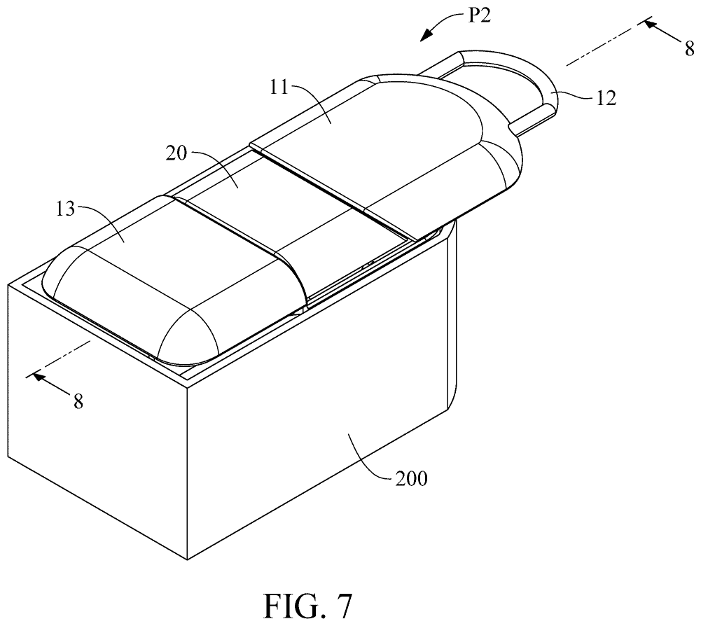

The main cushion body 10 includes a sliding cushion 11. The sliding cushion 11 is connected to the vehicle body (not shown) by the sliding structure 30 in between, so that the sliding cushion 11 is laterally slidably arranged over the opening 201 and is laterally slidable between a first position P1 (as shown in FIG. 3) and a second position P2 (as shown in FIG. 7). When the sliding cushion 11 is at the first position P1, the main cushion body 10 closes the opening 201; when the sliding cushion 11 is at the second position P2, the main cushion body 10 forms a space portion 12 in communication with the opening 201 (as shown in FIGS. 5 and 6). In one embodiment, the main cushion body 10 further includes a fixed cushion 13. The fixed cushion 13 is fixed to the vehicle body over the opening 201, and the space portion 12 is formed between the fixed cushion 13 and the sliding cushion 11 moved to the second position P2.

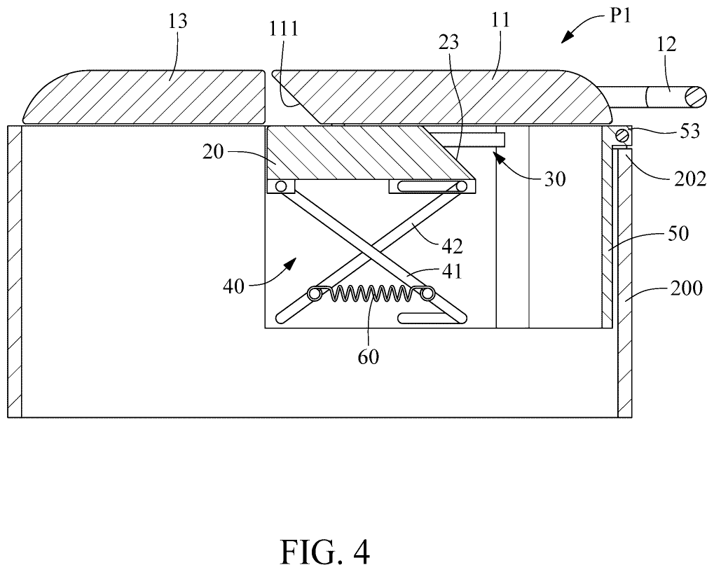

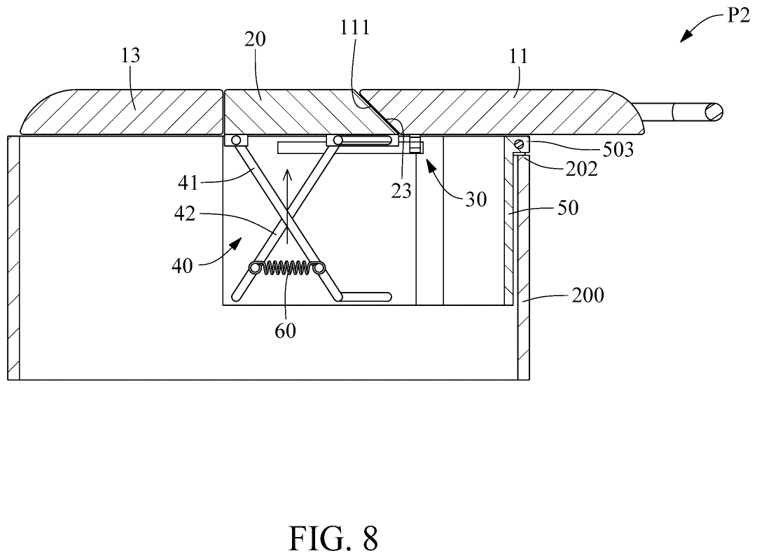

The lifting cushion 20 is connected to the vehicle body by the linkage mechanism 40 in between and can thus move into the carriage 20, and the lifting cushion 20 is at a position aligned with the space portion 12 and is thus longitudinally movable inside and outside the opening 201. When the sliding cushion 11 is at the first position P1, the lifting cushion 20 is moved into the carriage 200 (as shown in FIG. 4), and the length of the main cushion body 10 at this point in time is a total of the lengths of the sliding cushion 11 and the fixed cushion 13. When there is a need to increase the length of the main cushion body 10, a user can slide the sliding cushion 11 laterally to the second position P2 to form the space portion 12 (as shown in FIGS. 5 and 6), and the lifting cushion 20 can ascend from the inside of the carriage 200, move into the space portion 12 and then be positioned (as shown in FIGS. 7 and 8). At this point in time, the length of the main cushion body 10 is a total of the lengths of the three including the sliding cushion 11, the lifting cushion 20 and the fixed cushion 13, thereby achieving an effect of increasing the length of the main cushion body 10. The lifting cushion 20 can also descend again and move into the carriage 200 to move the sliding cushion 11 back to the first position P1, again restoring the main cushion body 10 back to a shortened state.

Thus, according to the description regarding adjusting the length of the main cushion body 10 above, the length of the main cushion body 10 can adjusted by the user. For example, in a scenario of riding only by one single passenger, the user can slide the sliding cushion 11 to the first position P1 and conceal the lifting cushion 20 in the carriage 200. At this point in time, the length of the sliding cushion 11 and the fixed cushion 13 is sufficient for the user to ride with comfort, and the overall length of the main cushion body 10 is also reduced so that the volume of the vehicle body is also reduced. For another example, in a scenario of riding by multiple passengers, the user only needs to slide the sliding cushion 11 to the second position P2 in a way that the lifting cushion 20 moves into the space portion 12 and is then positioned, and the length is increased since the lifting cushion 20 is added between the sliding cushion 11 and the fixed cushion 13. Thus, the overall length of the main cushion body 10 is sufficient for seating multiple passengers with comfort, thereby satisfying requirements for the seat cushion length in different riding scenarios for the user.

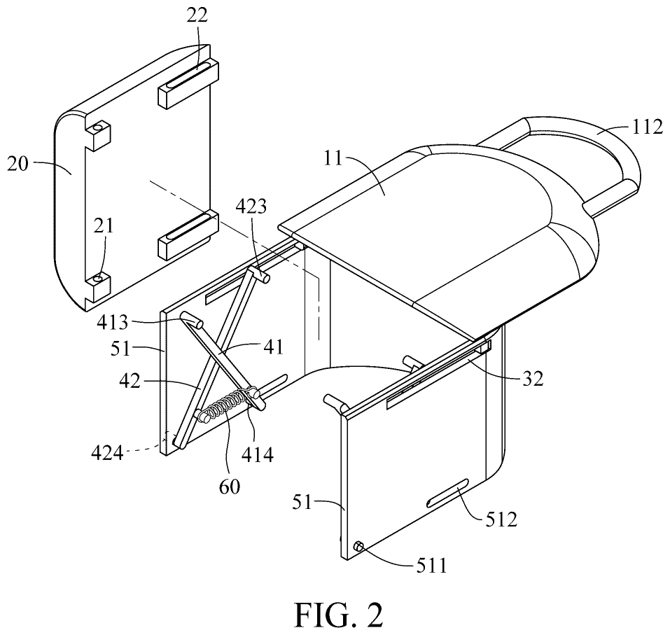

In one embodiment, as shown in FIGS. 1 and 2, the flip-up frame 50 includes two sidewalls 51 and a connecting wall 52. The two sidewalls 51 are disposed adjacent to two opposite inner walls inside the carriage 200. In the carriage 200, the two sidewalls 51 are parallel to each other and are structurally mirror-symmetrical (also referred to as reflection symmetrical), and the two sidewalls 51 are integrally connected by the connecting wall 52 on one side inside the carriage 200, hence forming the flip-up frame 50 by the two sidewalls 51 and the connecting wall 52. Thus, the two sidewalls 51 and the connecting wall 52 of the flip-up frame 50 are disposed along the inner wall of the carriage 200, and the top and the bottom of the flip-up frame 50 are hollow, so that the flip-up frame 50 does not occupy a space expected to be present inside the carriage 200.

The sliding structure 30 is arranged between the sliding cushion 11 and the two sidewalls 51. In one embodiment, the sliding structure 30 primarily includes two slide blocks 31 and two slide channels 32. The two slide blocks 31 are arranged on two sides of the sliding cushion 11, the two slide channels 32 are provided at the two sidewalls 51 and adjacent to the opening 201 (adjacent to upper edges of the two sidewalls 51 as shown in FIG. 1), and the sliding cushion 11 is slidably arranged in the two slide channels 32 of the two sidewalls 51 by the two slide blocks 31 on the two sides thereof. The sliding cushion 11 is capable of moving linearly and horizontally in accordance with travel distances of the two slide blocks 31 in the two slide channels 32, so as to slide between the first position P1 and the second position P2. Moreover, the sliding cushion 11 can be positioned when located at the first position P1 or the second position P2, by, for example, a positioning member (not shown) formed by a bead and a spring arranged between the slide blocks 31 and the slide channels 32.

The linkage mechanism 40 is arranged between the lifting cushion 20 and the two sidewalls 51. In one embodiment, the linkage mechanism 40 is provided with a set of a first link rod 41 and a second link rod 42 in a crossing manner corresponding to each of the sidewalls 51. The two sets of the first link rods 41 and the second link rods 42 are disposed by leaning against the two sidewalls 51 so as to reduce an occupied space in the flip-up frame 50. Two ends of each first link rod 41 have a first top end 411 and a first bottom end 412, respectively, and two ends of each second link rod 42 have a second top end 421 and a second bottom end 422, respectively. The first bottom end 412 and the second bottom end 422 are movably connected to the sidewall 51 where they are disposed, and the first top end 411 and the second top end 421 are movably connected to the lifting cushion 20. Thus, the first link rod 41 and the second link rod 42 of each set move relatively in a way that the first top end 411 moves close relative to the second top end 421 and the first bottom end 412 moves close relative to the second bottom end 422 (referring to FIG. 8), so as to link the lifting cushion 20 to ascend. Alternatively, the first top end 411 moves away relative to the second top end 421 and the first bottom end 412 moves away relative to the second bottom end 422 (referring to FIG. 4), so as to link the lifting cushion 20 to descend.

In one embodiment, a reset elastic member 60 is further included. A tension spring is taken as an example of the reset elastic member 60, which is connected between the first link rod 41 and the second link rod 42, so that the first link rod 41 and the second link rod 42 normally tend to have the first top end 411 to be close relative to the second top end 421 and the first bottom end 412 to be close relative to the second bottom end 422, so as to keep a tendency of the lifting cushion 20 rising normally. Moreover, the reset elastic member 60 can be a strong tension spring. When the lifting cushion 20 ascends and moves into the space portion 12, the lifting cushion 20 can be positioned in the space portion 12 by a retraction force of the reset elastic member 60. Alternatively, a positioning member (not shown) formed by, for example, a bead and a spring, can also be arranged between the lifting cushion 20 and the two sidewalls 51, so as to position the lifting cushion 20 moved into the space portion 12. In one embodiment, the sliding cushion 11 has a first oblique angle 111 on one side, the lifting cushion 20 has a second oblique angle 23 on one side, and slopes of the first oblique angle 111 and the second oblique angle 23 are the same; when the sliding cushion 11 moves to the second position P2 and the lifting cushion 20 ascends and moves into the space portion 12, the first oblique angle 111 and the second oblique angle 23 abut against each other and block each other, so that the lifting cushion 20 is positioned and is flush with the sliding cushion 11.

In continuation of the description above, in one embodiment, the linkage mechanism 40 is specifically structured to have a bottom of the lifting cushion 20 be provided with a first pivot hole 21 and a first guide groove 22 on each of two opposite sides, and the first pivot hole 21 and the first guide groove 22 on each side are arranged respectively in front of and behind the lifting cushion 20. Each of the two sidewalls 51 has a second pivot hole 511 disposed corresponding to the two first pivot holes 21, and has a second guide groove 512 disposed relative to the two first guide grooves 22. Each of the first link rods 41 has, at the first top end 411, a first rod 413 pivoted in the first pivot hole 21 on the same side of the lifting cushion 20, and each of the first link rods 41 has, at the first bottom end 412, a second rod 414 slidably disposed in the second guide groove 512 of the sidewall 51 on the same side. Each of the second link rods 42 has, at the second top end 421, a third rod 423 pivoted in the first guide groove 22 on the same side of the lifting cushion 20, and each of the second link rods 42 has, at the second bottom end 422, a fourth rod 424 slidably disposed in the second pivot hole 511.

In one embodiment, the flip-up frame 50 has a first pivot portion 53 protruding outward at a top end of the connecting wall 52. The vehicle body has, on the side of the carriage 200, a second pivot portion 202 disposed adjacent to the opening 201 (by means of shaft connection). The flip-up frame 50 is pivoted with the first pivot portion 53 and the second pivot portion 202 and is thus rotatably connected to the vehicle body, for the sliding cushion 11 and the lifting cushion 20 to be able to flip out of the carriage 200 from the opening 201 along with rotation of the flip-up frame 50. FIG. 9 shows a state in which the flip-up frame 50 is flipped up when the sliding cushion 11 is at the first position P1. At this point in time, the user can extend a hand into the carriage 200 to place or fetch the object O. FIG. 10 shows a state in which the flip-up frame 50 is flipped up when the sliding cushion 11 is at the first position P2, and the user can similarly extend a hand into the carriage 200 to place or fetch the object O.

In one embodiment, the sliding cushion 11 has a handle 112, which can be held by a hand so as to slide the sliding cushion 11. However, the seat assembly 100 of a vehicle of the present disclosure is not limited to sliding the sliding cushion 11 manually. The sliding cushion 11 can also be electrically driven, for example, driven by an electric motor (not shown). At this point in time, for example, a control signal is provided by a controller, and the sliding cushion 11 is driven by the electric motor to slide to the first position P1 (for example, by rotating the electric motor in a forward direction), or the sliding cushion 11 is driven by the electric motor to slide to the second position P2 (for example, by rotating the electric motor in a reverse direction). Moreover, the controller is remotely controllable, for example, remotely communicatively connected (for example, connected through Bluetooth) by a terminal device (for example, a smartphone), so that the sliding cushion 11 can be remotely controlled to slide to adjust the length of the main cushion body 10.

It is apparent from the description above that the present disclosure includes the following features.

1. In the seat assembly 100 of a vehicle of the present disclosure, the length of the main cushion body 10 can be reduced by sliding the sliding cushion 11 laterally to the first position P1 in coordination with descending of the lifting cushion 20. Alternatively, the sliding cushion 11 can also slide laterally to the second position P2 to form the space portion 12 and move into the space portion 12 in coordination with ascending of the lifting cushion 20, so as to increase the length of the main cushion body 10. Thus, the user can adjust the length of the main cushion body 10 according to one single passenger/rider or multiple passengers, thereby satisfying requirements for a seat cushion length in different riding scenarios for the user.

2. In the seat assembly 100 of a vehicle of the present disclosure, in addition to manually driving sliding of the sliding cushion 11, sliding of the sliding cushion 11 can also be driven by rotation in forward and reverse directions of the electric motor as described above. Thus, sliding of the sliding cushion 11 can be driven by means of remote control by a terminal device, hence more readily adjusting the length of the main cushion body 10 of the seat assembly 100.

The present disclosure is described by way of the preferred embodiments above. A person skilled in the art should understand that, these embodiments are merely for illustrating the present invention and are not to be construed as limitations to the scope of the present disclosure. It should be noted that all equivalent changes, replacements and substitutions made to the embodiments are encompassed within the scope of the present disclosure. Therefore, the legal protection for the present disclosure should be defined by the appended claims.

What is claimed is:

1. A seat assembly of a vehicle, the vehicle comprising in a vehicle body thereof a carriage for a user to place an object, the seat assembly adapted to be disposed at the vehicle body and being capable of opening or closing an opening of the carriage, the seat assembly comprising:
a main cushion body, comprising a sliding cushion, the sliding cushion connected to the vehicle body by a sliding structure in between, so that the sliding cushion is laterally slidably arranged over the opening and is laterally slidable between a first position and a second position, wherein the opening is closed by the main cushion body when the sliding cushion is at the first position, and the main cushion body forms a space portion in communication with the opening when the sliding cushion is at the second position; and
a lifting cushion, connected to the vehicle body by a linkage mechanism in between and thus capable of moving into the carriage, the lifting cushion being at a position aligned with the space portion and thus capable of longitudinally moving inside and outside the opening;
wherein, when the sliding cushion is at the first position, the lifting cushion is moved into the carriage; when the sliding cushion slides laterally to the second position and the space portion is formed, the lifting cushion is capable of ascending from the inside of the carriage, moving into the space portion and being positioned, or the lifting cushion is capable of descending again and moving into the carriage to move the sliding cushion back to the first position.

2. The seat assembly of a vehicle according to claim 1, further comprising:
two sidewalls, disposed adjacent to two opposite inner walls inside the carriage, the two sidewalls being parallel to each other inside the carriage and structurally mirror-symmetrical, wherein the sliding structure is arranged between the sliding cushion and the two sidewalls, and the linkage mechanism is arranged between the lifting cushion and the two sidewalls.

3. The seat assembly of a vehicle according to claim 2, wherein the linkage mechanism is provided with a set of a first link rod and a second link rod in a crossing manner corresponding to each of the sidewalls, two ends of the first link rod have a first top end and a first bottom end, respectively, and two ends of the second link rod have a second top end and a second bottom end, respectively, the first bottom end and the second bottom end are movably connected to the sidewall where they are disposed, and the first top end and the second top end are movably connected to the lifting cushion; when the first link rod and the second link rod move relatively, the first top end moves close relative to the second top end and the first bottom end moves close relative to the second bottom end, and the lifting cushion is linked and thus ascends, or the first top end moves away relative to the second top end and the first bottom end moves away relative to the second bottom end, and the lifting cushion is linked and thus descends.

4. The seat assembly of a vehicle according to claim 3, wherein a bottom of the lifting cushion has a first pivot hole and a first guide groove on each of two opposite sides, and the first pivot hole and the first guide groove on each side are arranged respectively in front of and behind the lifting cushion; each of the two sidewalls has a second pivot hole disposed corresponding to the two first pivot holes, and has a second guide groove disposed corresponding to the two first guide grooves; each of the first link rods has, at the first top end, a first rod pivoted in the first pivot hole on a same side of the lifting cushion, and each of the first link rods has, at the first bottom end, a second rod slidably disposed in the second guide groove of the sidewall on a same side; each of the second link rods has, at the second top end, a third rod pivoted in the first guide groove on a same side of the lifting cushion, and each of the second link rods has, at the second bottom end, a fourth rod slidably disposed in the second pivot hole.

5. The seat assembly of a vehicle according to claim 3, further comprising:
a reset elastic member, connected between the first link rod and the second link rod, so that the first link rod and the second link rod normally tend to have the first top end to be close relative to the second top end and the first bottom end to be close relative to the second bottom end, so as to keep a tendency of the lifting cushion rising normally.

6. The seat assembly of a vehicle according to claim 5, wherein the two sidewalls are connected integrally by a connecting wall on one side inside the carriage, the two sidewalls and the connecting wall form a flip-up frame having a hollow top and a hollow bottom, and the flip-up frame has a first pivot portion protruding outward at a top end of the connecting wall; the vehicle body has, on the side of the carriage, a second pivot portion disposed adjacent to the opening, and the flip-up frame is pivoted with the first pivot portion and the second pivot portion and is thus rotatably connected to the vehicle body, for the sliding cushion and the lifting cushion to be able to flip out of the carriage from the opening along with rotation of the flip-up frame.

7. The seat assembly of a vehicle according to claim 2, wherein the sliding structure comprises two slide blocks and two slide channels, the two slide blocks are arranged on two sides of the sliding cushion, and the two slide channels are disposed at the two sidewalls and adjacent to the opening, and the sliding cushion is slidably arranged in the two slide channels of the two sidewalls by the two slide blocks on the two sides thereof, so that the sliding cushion is capable of linearly and horizontally moving in accordance with travel distances of the two slide blocks in the two slide channels.

8. The seat assembly of a vehicle according to claim 1, wherein the main cushion body further comprises:
a fixed cushion, fixed to the vehicle body over the opening, and the space portion is formed between the fixed cushion and the sliding cushion moved to the second position.

9. The seat assembly of a vehicle according to claim 1, wherein the sliding cushion has a first oblique angle on one side, the lifting cushion has a second oblique angle on one side, and slopes of the first oblique angle and the second oblique angle are the same; when the sliding cushion moves to the second position and the lifting cushion ascends and moves into the space portion, the first oblique angle and the second oblique angle abut against each other and block each other, so that the lifting cushion is positioned and is flush with the sliding cushion.

10. The seat assembly of a vehicle according to claim 1, wherein the sliding cushion has a handle for a hand to hold and thus be slidable.
